(19) United States
(12) Patent Application Publication
(10) Pub. No.: US 2026/0229652 A1
(43) Pub. Date: Aug. 6, 2026

(54) BATTERY CELL, BATTERY, AND ELECTRIC APPARATUS

(71) Applicant: Ningde Amperex Technology Limited, Ningde City (CN)

(72) Inventors: Rui Li, Ningde City (CN); Peipei Guo, Ningde City (CN); Lin Li, Ningde City (CN); Zhiqi Huang, Ningde City (CN)

(73) Assignee: Ningde Amperex Technology Limited, Ningde City (CN)

(21) Appl. No.: 19/634,313

(22) Filed: Mar. 31, 2026

Related U.S. Application Data
(63) Continuation of application No. PCT/CN2024/127790, filed on Oct. 28, 2024.

(30) Foreign Application Priority Data
Nov. 1, 2023 (CN) 202311444061.2

(51) Int. Cl. H01M 50/105

(52) U.S. Cl. CPC H01M 50/105

(57) ABSTRACT

A packaging bag includes a first shell and a second shell. A first bonding layer of the first shell is bonded to a second bonding layer of the second shell to form a sealing portion. The sealing portion includes a first adhesive overflow region, a sealing region, and a second adhesive overflow region. The sealing region includes a first segment and a second segment. Along a width direction of the sealing portion, the sealing region is located between the first adhesive overflow region and the second adhesive overflow region. The second segment is closer to the electrode assembly than the first segment. An average thickness of the second segment is less than an average thickness of the first segment.

### CROSS-REFERENCE TO RELATED APPLICATIONS

This application is a continuation application of International Application No. PCT/CN2024/127790, filed on Oct. 28, 2024, which claims the benefit of Chinese Patent Application No. CN202311444061.2, filed on Nov. 1, 2023, the contents of which are incorporated herein by reference in its entirety.

### TECHNICAL FIELD

This application relates to the field of battery technology, and specifically, to a battery cell, a battery, and an electric apparatus.

### BACKGROUND

With the rapid development of electronic information technology, various electronic devices are advancing toward intelligence and multifunctionality, and increasingly high requirements are imposed on the reliability and service life of batteries. Therefore, how to improve the reliability and service life of batteries has become an urgent issue to be solved in the battery field.

### SUMMARY

This application provides a battery cell, a battery, and an electric apparatus, which can effectively improve the reliability and service life of a battery.

According to a first aspect, this application provides a battery cell including an electrode assembly and a packaging bag, where the packaging bag is configured to accommodate the electrode assembly, and the packaging bag includes a first shell and a second shell; the first shell includes a first bonding layer; the second shell includes a second bonding layer; the first bonding layer is bonded to the second bonding layer to form a sealing portion; the sealing portion includes a first adhesive overflow region, a sealing region, and a second adhesive overflow region; along a width direction of the sealing portion, the sealing region is located between the first adhesive overflow region and the second adhesive overflow region; the sealing region includes a first segment and a second segment; along the width direction of the sealing portion, the second segment is closer to the electrode assembly than the first segment; and an average thickness of the second segment is less than an average thickness of the first segment.

In the above technical solution, the battery cell includes the packaging bag configured to accommodate the electrode assembly and capable of protecting the electrode assembly. The packaging bag includes the first shell and the second shell. The first bonding layer of the first shell and the second bonding layer of the second shell form the sealing portion, so that the space in the packaging bag for accommodating the electrode assembly can be sealed, reducing the probability of electrolyte leakage within the packaging bag, and enabling the battery cell to operate normally. The sealing portion includes the first adhesive overflow region, the sealing region, and the second adhesive overflow region; along the width direction of the sealing portion, the sealing region is located between the first adhesive overflow region and the second adhesive overflow region; the sealing region includes the first segment and the second segment; along the width direction of the sealing portion, the second segment is closer to the electrode assembly than the first segment; and the average thickness of the second segment is less than the average thickness of the first segment. This allows the second segment to have a smaller cross-sectional area in the width direction of the sealing portion, thereby allowing for a small amount of water vapor permeating into the packaging bag through the sealing region, slowing down an expansion speed of the packaging bag, reducing the probability of the packaging bag rupturing and causing electrolyte leakage and failure of the battery cell, and improving the reliability and service life of a battery. In addition, the sealing performance of the sealing region is good, so that the first shell and the second shell in the sealing region are less likely to separate and cause electrolyte leakage.

In some embodiments, the average thickness of the first segment is H1, and the average thickness of the second segment is H2; where 13%≤H2/H1≤80%.

In the above technical solution, the average thickness H1 of the first segment and the average thickness H2 of the second segment satisfy 13%≤H2/H1≤80%. This can prevent the volume of the first adhesive overflow region and/or the second adhesive overflow region from being excessively large, and make the sealing region less prone to cracking due to bending, which otherwise causes corrosion on other layer structures of the first shell and/or the second shell by an electrolyte. In addition, this allows for a small amount of water vapor permeating into the packaging bag through the sealing region, thereby slowing down the expansion speed of the packaging bag, reducing the probability of the packaging bag rupturing and causing electrolyte leakage and failure of the battery cell, and improving the reliability and service life of the battery.

In some embodiments, the average thickness of the first segment is H1, and the average thickness of the second segment is H2; where 35 μm≤H1≤110 μm, and 10 μm≤H2≤60 μm.

In the above technical solution, the average thickness H1 of the first segment satisfies 35 μm≤H1≤110 μm. This allows for a relatively high bonding strength between the first shell and the second shell, resulting in good sealing performance of the packaging bag, and reducing the probability of electrolyte leakage. In addition, this allows for a small amount of water vapor permeating into the packaging bag through the sealing region.

The average thickness H2 of the second segment satisfies 10 μm≤H2≤60 μm. This can prevent the volume of the first adhesive overflow region and/or the second adhesive overflow region from being excessively large, and make the sealing region less prone to cracking due to bending, which otherwise causes corrosion on other layer structures of the first shell and/or the second shell by an electrolyte. In addition, this allows for a small amount of water vapor permeating into the packaging bag through the sealing region, thereby slowing down the expansion speed of the packaging bag, reducing the probability of the packaging bag rupturing and causing electrolyte leakage and failure of the battery cell, and improving the reliability and service life of the battery.

In some embodiments, the sealing region further includes a first transition segment, where the first transition segment is connected between the first segment and the second segment; and a thickness of the first transition segment gradually increases along a direction leaving the electrode assembly.

In the above technical solution, the sealing region further includes the first transition segment; the first transition segment is connected between the first segment and the second segment; and the thickness of the first transition segment gradually increases along the direction leaving the electrode assembly. This allows for a smooth transition between the first segment and the second segment with different thicknesses, facilitating the press-forming of the first segment and the second segment.

In some embodiments, the sealing region further includes a third segment; along the width direction of the sealing portion, the second segment is disposed between the third segment and the first segment; and the average thickness of the second segment is less than an average thickness of the third segment.

In the above technical solution, the sealing region further includes the third segment; along the width direction of the sealing portion, the second segment is disposed between the third segment and the first segment; and the average thickness of the second segment is less than the average thickness of the third segment. This can prevent the volume of the adhesive overflow region on a side of the sealing region close to the electrode assembly from being excessively large, thereby reducing the occupation of an internal space of the packaging bag by the adhesive overflow region on the side of the sealing region close to the electrode assembly, and helping to increase the energy density of the battery.

In some embodiments, the average thickness of the first segment is H1, the average thickness of the second segment is H2, and the average thickness of the third segment is H3; where 13%≤H2/H1≤80%, and 13%≤H2/H3≤80%.

In the above technical solution, the average thickness H1 of the first segment and the average thickness H2 of the second segment satisfy 13%≤H2/H1≤80%; and the average thickness H2 of the second segment and the average thickness H3 of the third segment satisfy 13%≤H2/H3≤80%. This can prevent the volumes of the first adhesive overflow region and the second adhesive overflow region from being excessively large, and make the sealing region less prone to cracking due to bending, which otherwise causes corrosion on other layer structures of the first shell and/or the second shell by the electrolyte. In addition, this allows for a small amount of water vapor permeating into the packaging bag through the sealing region, thereby slowing down the expansion speed of the packaging bag, reducing the probability of the packaging bag rupturing and causing electrolyte leakage and failure of the battery cell, and improving the reliability and service life of the battery.

In some embodiments, the average thickness of the first segment is H1, the average thickness of the second segment is H2, and the average thickness of the third segment is H3; where 35 μm≤H1≤110 μm, 10 μm≤H2≤60 μm, and 35 μm≤H3≤110 μm.

In the above technical solution, the average thickness H1 of the first segment and the average thickness H3 of the third segment satisfy 35 μm≤H1≤110 μm and 35 μm≤H3≤110 μm. This allows for a relatively high bonding strength between the first shell and the second shell, resulting in good sealing performance of the packaging bag, and reducing the probability of electrolyte leakage. In addition, this allows for a small amount of water vapor permeating into the packaging bag through the sealing region.

The average thickness H2 of the second segment satisfies 10 μm≤H2≤60 μm. This can prevent the volumes of the first adhesive overflow region and the second adhesive overflow region from being excessively large, and make the sealing region less prone to cracking due to bending, which otherwise causes corrosion on other layer structures of the first shell and/or the second shell by the electrolyte. In addition, this allows for a smaller amount of water vapor permeating into the packaging bag through the sealing region, thereby slowing down the expansion speed of the packaging bag, reducing the probability of the packaging bag rupturing and causing electrolyte leakage and failure of the battery cell, and improving the reliability and service life of the battery.

In some embodiments, a width of the first segment is W1, a width of the second segment is W2, a width of the third segment is W3, and a width of the sealing region is W; where 5%≤W1/W≤50%, 5%≤W2/W≤50%, and 5%≤W3/W≤50%.

In the above technical solution, the width W1 of the first segment, the width W3 of the third segment, and the width W of the sealing region satisfy 5%≤W1/W≤50% and 5%≤W3/W≤50%. This allows for a relatively high bonding strength between the first shell and the second shell, resulting in good sealing performance of the packaging bag, and reducing the probability of electrolyte leakage. In addition, this allows for a small amount of water vapor permeating into the packaging bag through the sealing region.

The width W2 of the second segment and the width W of the sealing region satisfy 5%≤W2/W≤50%. This allows for a small amount of water vapor permeating into the packaging bag through the sealing region. In addition, this can prevent the volumes of the first adhesive overflow region and the second adhesive overflow region from being excessively large, and make the sealing region less prone to cracking due to bending, which otherwise causes corrosion on other layer structures of the first shell and/or the second shell by the electrolyte.

In some embodiments, the width of the first segment is W1, the width of the second segment is W2, the width of the third segment is W3, and the width of the sealing region is W, satisfying 0.15 mm≤W1≤4 mm, 0.15 mm≤W2≤4 mm, 0.15 mm≤W3≤4 mm, and 3 mm≤W≤8 mm.

In the above technical solution, the width W1 of the first segment and the width W3 of the third segment satisfy 0.15 mm≤W1≤4 mm and 0.15 mm≤W3≤4 mm. This allows for a relatively high bonding strength between the first shell and the second shell, resulting in good sealing performance of the packaging bag, and reducing the probability of electrolyte leakage. In addition, this allows the space occupied by the first segment and the third segment to be relatively small, helping to increase the energy density of the battery.

The width W2 of the second segment satisfies 0.15 mm≤W2≤4 mm. This allows for a small amount of water vapor permeating into the packaging bag through the sealing region. In addition, this can prevent the volumes of the first adhesive overflow region and the second adhesive overflow region from being excessively large, and make the sealing region less prone to cracking due to bending, which otherwise causes corrosion on other layer structures of the first shell and/or the second shell by the electrolyte.

The width W of the sealing region satisfies 3 mm≤W≤8 mm. This allows for a relatively high bonding strength between the first shell and the second shell, resulting in good sealing performance of the packaging bag, and reducing the probability of electrolyte leakage. In addition, this allows the space occupied by the sealing region to be relatively small, helping to increase the energy density of the battery.

In some embodiments, the sealing region further includes a second transition segment, where the second transition segment is connected between the second segment and the third segment, and a thickness of the second transition segment gradually increases along a direction approaching the electrode assembly.

In the above technical solution, the sealing region further includes the second transition segment; the second transition segment is connected between the second segment and the third segment; and the thickness of the second transition segment gradually increases in the direction approaching the electrode assembly. This allows for a smooth transition between the second segment and the third segment with different thicknesses, facilitating the press-forming of the second segment and the third segment.

In some embodiments, a surface of the second segment along a thickness direction is a flat surface or a concave-convex surface.

In the above technical solution, the surface of the second segment along the thickness direction being a flat surface facilitates the press-forming of the second segment. The surface of the second segment along the thickness direction being a concave-convex surface can enhance the bonding strength between the first shell and the second shell.

According to a second aspect, this application provides a battery including the foregoing battery cell.

According to a third aspect, this application provides an electric apparatus including the above battery, where the battery is configured to provide electrical energy.

### BRIEF DESCRIPTION OF DRAWINGS

To more clearly illustrate the technical solutions of some embodiments of this application, the drawings required for describing these embodiments are briefly described below. It should be understood that the following drawings only illustrate some embodiments of this application and thus should not be considered as limitations on the scope. Those of ordinary skill in the art may still derive other related drawings from these drawings without creative efforts.

FIG. 1 is a schematic structural diagram of a battery cell according to some embodiments of this application;

FIG. 2 is a schematic cross-sectional structural diagram of the battery cell in FIG. 1 along A-A;

FIG. 3 is a schematic structural diagram of a battery cell according to some other embodiments of this application;

FIG. 4 is a schematic cross-sectional structural diagram of the battery cell in FIG. 3 along B-B; and

FIG. 5 is a schematic diagram of a partial structure of a battery cell according to some embodiments of this application.

Reference signs: 10. battery cell; 100. electrode assembly; 200. packaging bag; 210. first shell; 211. first bonding layer; 212. first metal layer; 213. first connection layer; 214. first protective layer; 220. second shell; 221. second bonding layer; 222. second metal layer; 223. second connection layer; 224. second protective layer; 230. sealing portion; 231. first adhesive overflow region; 232. sealing region; 2321. first segment; 2322. second segment; 2323. first transition segment; 2324. third segment; 2325. second transition segment; 233. second adhesive overflow region; X. width direction of battery cell; Y. length direction of battery cell; and Z. thickness direction of battery cell.

### DETAILED DESCRIPTION

To make the objectives, technical solutions, and advantages of this application clearer, the technical solutions in some embodiments of this application are clearly described below in conjunction with the drawings in these embodiments of this application. Apparently, the described embodiments are only some rather than all of these embodiments of this application. Based on these embodiments in this application, all other embodiments obtained by those of ordinary skill in the art fall within the protection scope of this application.

Unless otherwise defined, all technical and scientific terms used in this application have the same meaning as commonly understood by those skilled in the art of this application. The terms used in the specification of this application are only for the purpose of describing specific embodiments and are not intended to limit this application. The terms “include”, “have”, and any variations thereof in the specification and claims of this application as well as the foregoing description of the drawings are intended to cover non-exclusive inclusions.

The terms “first”, “second”, and the like in the specification, claims, or the above drawings of this application are used to distinguish different objects and are not used to describe a specific order or primary-secondary relationship.

Reference to “embodiment” in this application means that specific features, structures, or characteristics described with reference to this embodiment may be included in at least one embodiment of this application. The word “embodiment” appearing in various places in this specification does not necessarily refer to the same embodiment or an independent or alternative embodiment that is exclusive of other embodiments.

In the description of this application, it should be noted that unless otherwise specified and defined explicitly, the terms “mounting”, “connection”, “join”, and “attachment” should be understood in their general senses. For example, they may refer to a fixed connection, a detachable connection, or an integral connection, and may refer to a direct connection, an indirect connection via an intermediate medium, or an internal communication between two elements. Those of ordinary skill in the art can understand specific meanings of these terms in this application as suitable to specific situations.

In some embodiments of this application, the same reference signs denote the same components. For brevity, in different embodiments, detailed descriptions of the same components are not repeated. It should be understood that, as shown in the accompanying drawings, dimensions such as thickness, length, and width of various components and dimensions such as thickness, length, and width of integrated devices in these embodiments of this application are merely for illustrative purposes and should not constitute any limitations on this application.

With the development of the new energy industry, increasingly high requirements are imposed on the reliability and service life of batteries. Currently, a battery cell sealed with a packaging bag is typically provided with a first shell and a second shell, where a first bonding layer of the first shell and a second bonding layer of the second shell form a sealing portion to seal the electrode assembly. However, a small thickness of a sealing region of the sealing portion leads to poor bonding strength between the first shell and the second shell. A large thickness of the sealing region leads to a large amount of water vapor permeating into the packaging bag through the sealing region, accelerating an expansion speed of the packaging bag, leading to rupture of the packaging bag and thus causing electrolyte leakage and failure, and resulting in low reliability and short service life of the battery.

To improve the reliability and service life of the battery, an embodiment of this application provides a battery cell including an electrode assembly and a packaging bag, where the packaging bag is configured to accommodate the electrode assembly, and the packaging bag includes a first shell and a second shell. The first shell includes a first bonding layer. The second shell includes a second bonding layer. The first bonding layer is bonded to the second bonding layer to form a sealing portion. The sealing portion includes a first adhesive overflow region, a sealing region, and a second adhesive overflow region. Along a width direction of the sealing portion, the sealing region is located between the first adhesive overflow region and the second adhesive overflow region. The sealing region includes a first segment and a second segment. Along the width direction of the sealing portion, the second segment is closer to the electrode assembly than the first segment. An average thickness of the second segment is less than an average thickness of the first segment.

In the battery cell with this structure, the battery cell includes the packaging bag configured to accommodate the electrode assembly and capable of protecting the electrode assembly. The packaging bag includes the first shell and the second shell. The first bonding layer of the first shell and the second bonding layer of the second shell form the sealing portion, so that the space in the packaging bag for accommodating the electrode assembly can be sealed, reducing the probability of electrolyte leakage within the packaging bag, and enabling the battery cell to operate normally. The sealing portion includes the first adhesive overflow region, the sealing region, and the second adhesive overflow region; and along the width direction of the sealing portion, the sealing region is located between the first adhesive overflow region and the second adhesive overflow region; the sealing region includes the first segment and the second segment; and along the width direction of the sealing portion, the second segment is closer to the electrode assembly than the first segment; and the average thickness of the second segment is less than the average thickness of the first segment. This allows the second segment to have a smaller cross-sectional area in the width direction of the sealing portion, thereby allowing for a smaller amount of water vapor permeating into the packaging bag through the sealing region, slowing down an expansion speed of the packaging bag, reducing the probability of the packaging bag rupturing and causing electrolyte leakage and failure of the battery cell, and improving the reliability and service life of a battery. In addition, the sealing performance of the sealing region is good, so that the first shell and the second shell in the sealing region are less likely to separate and cause electrolyte leakage.

An embodiment of this application provides a battery including the battery cell, where the battery may be a secondary battery or a primary battery. For example, the battery may be a lithium-ion battery, a sodium-ion battery, or a magnesium-ion battery. This is not limited in this embodiment of this application. The battery may be cylindrical, flat, cuboid, or of other shapes, which is not limited in this embodiment of this application.

An embodiment of this application provides an electric apparatus using a battery as a power source, where the electric apparatus may be but is not limited to a mobile phone, a tablet, a laptop, an electric toy, an electric tool, an electric bicycle, an electric vehicle, a ship, or a spacecraft.

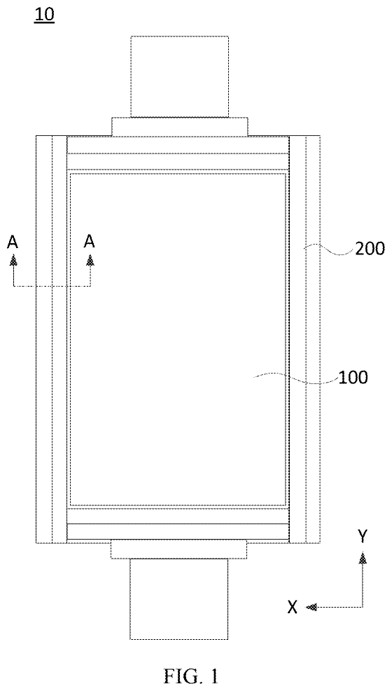

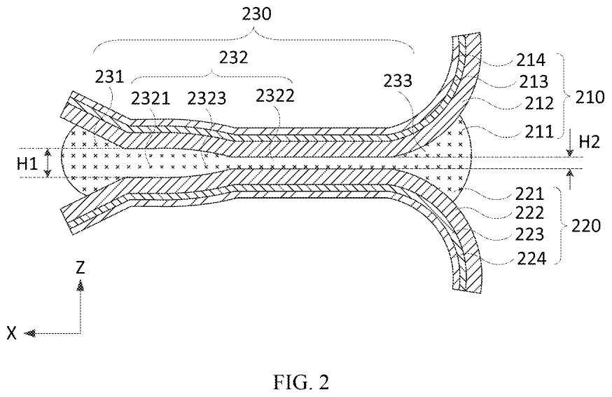

Referring to FIG. 1 and FIG. 2, FIG. 1 is a schematic structural diagram of a battery cell according to some embodiments of this application. FIG. 2 is a schematic cross-sectional structural diagram of the battery cell in FIG. 1 along A-A.

An embodiment of this application provides a battery cell 10. The battery cell 10 includes an electrode assembly 100 and a packaging bag 200. The packaging bag 200 is configured to accommodate the electrode assembly 100, and the packaging bag 200 includes a first shell 210 and a second shell 220. The first shell 210 includes a first bonding layer 211. The second shell 220 includes a second bonding layer 221. The first bonding layer 211 is bonded to the second bonding layer 221 to form a sealing portion 230. The sealing portion 230 includes a first adhesive overflow region 231, a sealing region 232, and a second adhesive overflow region 233. Along a width direction (X and Y) of the sealing portion 230, the sealing region 232 is located between the first adhesive overflow region 231 and the second adhesive overflow region 233. The sealing region 232 includes a first segment 2321 and a second segment 2322. Along the width direction (X and Y) of the sealing portion 230, the second segment 2322 is closer to the electrode assembly 100 than the first segment 2321. An average thickness of the second segment 2322 is less than an average thickness of the first segment 2321.

A thickness of the first segment 2321 and a thickness of the second segment 2322 each refer to a thickness after the first bonding layer 211 and the second bonding layer 221 are bonded or fused.

In some embodiments, the average thickness of the first segment 2321 can be obtained by dividing the first segment 2321 into multiple equal segments along the width direction (X and Y) of the sealing portion 230, summing the thicknesses of the segments, and dividing by the number of segments. Calculation methods of average thicknesses of other portions are similar. In some embodiments, the first bonding layer 211 and the second bonding layer 221 are bonded to form four sealing portions 230 that are respectively located at four sides of the battery cell 10. All four sealing portions 230 satisfy that the average thickness of the second segment 2322 is less than the average thickness of the first segment 2321.

In some other embodiments, alternatively, only one, two, or three of the four sealing portions 230 may satisfy that the average thickness of the second segment 2322 is less than the average thickness of the first segment 2321.

In some other embodiments, alternatively, the sealing portion 230 may partially satisfy that the average thickness of the second segment 2322 is less than the average thickness of the first segment 2321.

In some embodiments, the electrode assembly 100 includes a positive electrode plate, a negative electrode plate, and a separator. The battery cell primarily operates by the movement of metal ions between the positive electrode plate and the negative electrode plate. The positive electrode plate includes a positive electrode current collector and a positive electrode active material layer, where the positive electrode active material layer is applied on a surface of the positive electrode current collector. A portion of the positive electrode current collector not coated with the positive electrode active material layer serves as a positive electrode tab to enable the input or output of electrical energy of the positive electrode plate through the positive electrode tab. With a lithium-ion battery as an example, the material of the positive electrode current collector may be aluminum. The positive electrode active material may be lithium cobalt oxide, lithium iron phosphate, a ternary material, lithium manganese oxide, or the like. The negative electrode plate includes a negative electrode current collector and a negative electrode active material layer, where the negative electrode active material layer is applied on a surface of the negative electrode current collector. A portion of the negative electrode current collector not coated with the negative electrode active material layer serves as a negative electrode tab to enable the input or output of electrical energy of the negative electrode plate through the negative electrode tab. The material of the negative electrode current collector may be copper. The negative electrode active material may be a carbon material, a silicon material, or the like. The material of the separator may be polypropylene (PP), polyethylene (PE), or the like. An electrolyte may include an organic solvent, an electrolyte lithium salt, or the like.

In some embodiments, the electrode assembly 100 may be a laminated structure formed by stacking a negative electrode plate, a separator, and a positive electrode plate.

In some other embodiments, the electrode assembly 100 may alternatively be a wound structure formed by winding the negative electrode plate, the separator, and the positive electrode plate.

In some embodiments, the first bonding layer 211 and the second bonding layer 221 may each be made of a polypropylene (PP, Polypropylene) material and is capable of melting when heated, so that the first bonding layer 211 and the second bonding layer 221 are fused together, resulting in a relatively high bonding strength between the first shell 210 and the second shell 220.

In some embodiments, a width direction X of the battery cell 10, a length direction Y of the battery cell 10, and a thickness direction Z of the battery cell 10 are perpendicular to each other. The sealing portion 230 is disposed on a periphery or at least three sides of the electrode assembly 100. The width direction of the sealing portion 230 includes both X and Y directions. A thickness direction of the sealing portion 230 is the thickness direction Z of the battery cell 10.

In some embodiments, a material of the sealing region 232 is extruded to overflow and form the first adhesive overflow region 231 and the second adhesive overflow region 233. A smaller thickness formed by the extrusion of the sealing region 232 leads to more overflowing materials, resulting in larger volumes of the first adhesive overflow region 231 and the second adhesive overflow region 233.

In some embodiments, the thickness of the first segment 2321 is a dimension of the first segment 2321 in the thickness direction Z of the sealing portion 230. The thickness of the second segment 2322 is a dimension of the second segment 2322 in the thickness direction Z of the sealing portion 230.

The battery cell 10 includes the packaging bag 200 configured to accommodate the electrode assembly 100 and capable of protecting the electrode assembly 100. The packaging bag 200 includes the first shell 210 and the second shell 220. The first bonding layer 211 of the first shell 210 and the second bonding layer of the second shell 220 form the sealing portion 230, so that the space in the packaging bag 200 for accommodating the electrode assembly 100 can be sealed, reducing the probability of electrolyte leakage within the packaging bag 200, and enabling the battery cell 10 to operate normally. The sealing portion 230 includes the first adhesive overflow region 231, the sealing region 232, and the second adhesive overflow region 233. Along the width direction (X and Y) of the sealing portion 230, the sealing region 232 is located between the first adhesive overflow region 231 and the second adhesive overflow region 233. The sealing region 232 includes the first segment 2321 and the second segment 2322. Along the width direction (X and Y) of the sealing portion 230, the second segment 2322 is closer to the electrode assembly 100 than the first segment 2321. The average thickness of the second segment 2322 is less than the average thickness of the first segment 2321. This allows the second segment 2322 to have a smaller cross-sectional area in the width direction (X and Y) of the sealing portion 230, thereby allowing for a smaller amount of water vapor permeating into the packaging bag 200 through the sealing region 232, slowing down an expansion speed of the packaging bag 200, reducing the probability of the packaging bag 200 rupturing and causing electrolyte leakage and failure of the battery cell 10, and improving the reliability and service life of the battery. In addition, the sealing performance of the sealing region is good, so that the first shell and the second shell in the sealing region are less likely to separate and cause electrolyte leakage.

In some embodiments, the average thickness of the first segment 2321 is H1, and the average thickness of the second segment 2322 is H2; where 13%≤H2/H1≤80%. For example, H2/H1 may be 13%, 46%, 80%, or the like.

To reduce the space occupied by the battery cell, after the electrode assembly 100 is sealed with the packaging bag 200, the sealing portion 230 of the packaging bag 200 can also be bent. When the thickness of the sealing region 232 is excessively small, the sealing region 232 may crack during bending, and the electrolyte inside the packaging bag 200 may permeate into other layer structures of the first shell 210 and/or the second shell 220 through gaps formed by the cracking of the sealing region 232, thus resulting in corrosion on other layer structures, and causing the issues such as damage to the packaging bag 200 and electrolyte leakage. The average thickness H1 of the first segment 2321 and the average thickness H2 of the second segment 2322 satisfy 13%≤H2/H1≤80%. This can prevent the volume of the first adhesive overflow region 231 and/or the second adhesive overflow region 233 from being excessively large, and make the sealing region 232 less prone to cracking due to bending, which otherwise causes corrosion on other layer structures of the first shell 210 and/or the second shell 220 by the electrolyte. In addition, this allows for a small amount of water vapor permeating into the packaging bag 200 through the sealing region 232, thereby slowing down the expansion speed of the packaging bag 200, reducing the probability of the packaging bag 200 rupturing and causing electrolyte leakage and failure of the battery cell 10, and improving the reliability and service life of the battery.

In some embodiments, the average thickness of the first segment 2321 is H1, and the average thickness of the second segment 2322 is H2; where 35 μm≤H1≤110 μm, and 10 μm≤H2≤60 μm. For example, H1 may be 35 μm, 72 μm, 110 μm, or the like. H2 may be 10 μm, 35 μm, 60 μm, or the like.

The average thickness H1 of the first segment 2321 satisfies 35 μm≤H1≤110 μm. This allows for a relatively high bonding strength between the first shell 210 and the second shell 220, resulting in good sealing performance of the packaging bag 200, and reducing the probability of electrolyte leakage. In addition, this allows for a small amount of water vapor permeating into the packaging bag 200 through the sealing region 232.

The average thickness H2 of the second segment 2322 satisfies 10 μm≤H2≤60 μm. This can prevent the volume of the first adhesive overflow region 231 and/or the second adhesive overflow region 233 from being excessively large, and make the sealing region 232 less prone to cracking due to bending, which otherwise causes corrosion on other layer structures of the first shell 210 and/or the second shell 220 by the electrolyte. In addition, this allows for a smaller amount of water vapor permeating into the packaging bag 200 through the sealing region 232, thereby slowing down the expansion speed of the packaging bag 200, reducing the probability of the packaging bag 200 rupturing and causing electrolyte leakage and failure of the battery cell 10, and improving the reliability and service life of the battery.

In some embodiments, a width of the first segment 2321 is W1, a width of the second segment 2322 is W2, and a width of the sealing region 232 is W; where 5%≤W1/W≤50%, and 5%≤W2/W≤50%. For example, W1/W may be 5%, 25%, 50%, or the like. W2/W may be 5%, 30%, 50%, or the like.

The width W1 of the first segment 2321 and the width W of the sealing region 232 satisfy 5%≤W1/W≤50%. This allows for a relatively high bonding strength between the first shell 210 and the second shell 220, resulting in good sealing performance of the packaging bag 200, and reducing the probability of electrolyte leakage. In addition, this allows for a small amount of water vapor permeating into the packaging bag 200 through the sealing region 232.

The width W2 of the second segment 2322 and the width W of the sealing region 232 satisfy 5%≤W2/W≤50%. This allows for a small amount of water vapor permeating into the packaging bag 200 through the sealing region 232. In addition, this can prevent the volumes of the first adhesive overflow region 231 and the second adhesive overflow region 233 from being excessively large, and make the sealing region 232 less prone to cracking due to bending, which otherwise causes corrosion on other layer structures of the first shell 210 and/or the second shell 220 by the electrolyte.

In some embodiments, the width of the first segment 2321 is W1, the width of the second segment 2322 is W2, and the width of the sealing region 232 is W, satisfying 0.15 mm≤W1≤4 mm, 0.15 mm≤W2≤4 mm, and 3 mm≤W≤8 mm. For example, W1 may be 0.15 mm, 1.8 mm, 4 mm, or the like. W2 may be 0.15 mm, 2.3 mm, 4 mm, or the like. W may be 3 mm, 5 mm, 8 mm, or the like.

The width W1 of the first segment 2321 satisfies 0.15 mm≤W1≤4 mm. This allows for a relatively high bonding strength between the first shell 210 and the second shell 220, resulting in good sealing performance of the packaging bag 200, and reducing the probability of electrolyte leakage. In addition, this allows the space occupied by the first segment 2321 to be relatively small, helping to increase the energy density of the battery.

The width W2 of the second segment 2322 satisfies 0.15 mm≤W2≤4 mm. This allows for a small amount of water vapor permeating into the packaging bag 200 through the sealing region 232. In addition, this can prevent the volumes of the first adhesive overflow region 231 and the second adhesive overflow region 233 from being excessively large, and make the sealing region 232 less prone to cracking due to bending, which otherwise causes corrosion on other layer structures of the first shell 210 and/or the second shell 220 by the electrolyte.

The width W of the sealing region 232 satisfies 3 mm≤W≤8 mm. This allows for a relatively high bonding strength between the first shell 210 and the second shell 220, resulting in good sealing performance of the packaging bag 200, and reducing the probability of electrolyte leakage. In addition, this allows the space occupied by the sealing region 232 to be relatively small, helping to increase the energy density of the battery.

In some embodiments, the sealing region 232 further includes a first transition segment 2323, where the first transition segment 2323 is connected between the first segment 2321 and the second segment 2322; and a thickness of the first transition segment 2323 gradually increases along a direction leaving the electrode assembly 100.

In some embodiments, the thickness of the first transition segment 2323 is a dimension of the first transition segment 2323 in the thickness direction Z of the sealing portion 230.

The sealing region 232 further includes the first transition segment 2323; the first transition segment 2323 is connected between the first segment 2321 and the second segment 2322; and the thickness of the first transition segment 2323 gradually increases along the direction leaving the electrode assembly 100. This allows for a smooth transition between the first segment 2321 and the second segment 2322 with different thicknesses, facilitating the press-forming of the first segment 2321 and the second segment 2322.

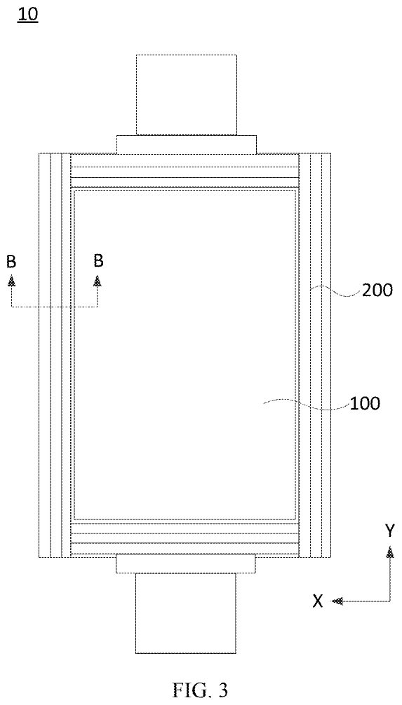

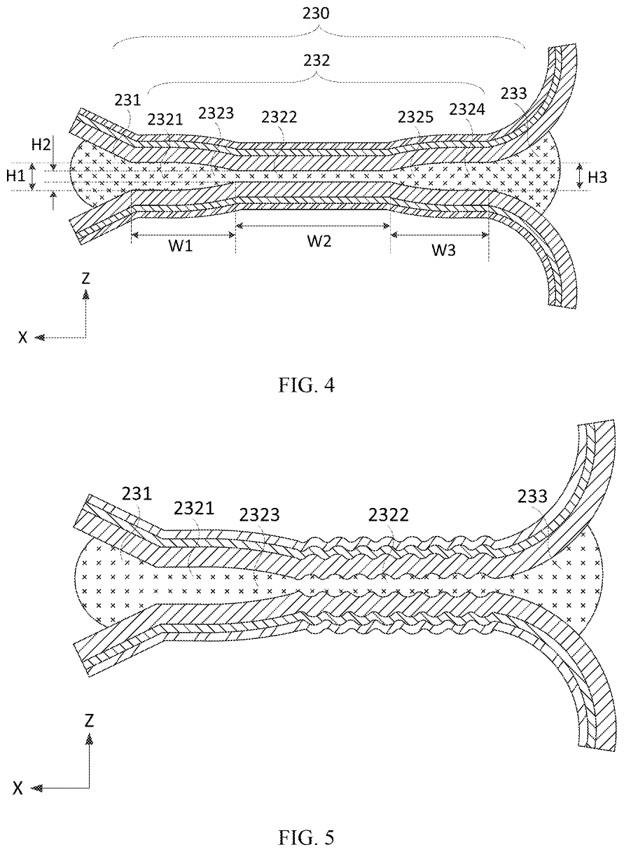

Referring to FIG. 3 and FIG. 4, FIG. 3 is a schematic structural diagram of a battery cell according to some other embodiments of this application. FIG. 4 is a schematic cross-sectional structural diagram of the battery cell in FIG. 3 along B-B.

In some embodiments, the sealing region 232 further includes a third segment 2324. Along the width direction (X and Y) of the sealing portion 230, the second segment 2322 is disposed between the third segment 2324 and the first segment 2321. The average thickness of the second segment 2322 is less than an average thickness of the third segment 2324.

In some embodiments, the thickness of the third segment 2324 is a dimension of the third segment 2324 in the thickness direction Z of the sealing portion 230.

A smaller thickness of the sealing region 232 leads to a larger volume of an adhesive overflow region adjacent to the sealing region 232. The sealing region 232 further includes the third segment 2324. Along the width direction (X and Y) of the sealing portion 230, the second segment 2322 is disposed between the third segment 2324 and the first segment 2321, so that the material overflowing from the second segment 2322 does not directly form an adhesive overflow region. In addition, the average thickness of the second segment 2322 is less than the average thickness of the third segment 2324. Fewer materials overflow from the third segment 2324 compared to the second segment 2322. Therefore, this can prevent the volume of the adhesive overflow region (the second adhesive overflow region 233) on a side of the sealing region 232 close to the electrode assembly 100 from being excessively large, thereby reducing the occupation of an internal space of the packaging bag 200 by the adhesive overflow region (the second adhesive overflow region 233) on the side of the sealing region 232 close to the electrode assembly 100, and helping to increase the energy density of the battery.

In some embodiments, the average thickness of the first segment 2321 is H1, the average thickness of the second segment 2322 is H2, and the average thickness of the third segment 2324 is H3; where 13%≤H2/H1≤80%, and 13%≤H2/H3≤80%. For example, H2/H1 may be 13%, 50%, 80%, or the like. H2/H3 may be 13%, 55%, 80%, or the like.

The average thickness H1 of the first segment 2321 and the average thickness H2 of the second segment 2322 satisfy 13%≤H2/H1≤80%; and the average thickness H2 of the second segment 2322 and the average thickness H3 of the third segment 2324 satisfy 13%≤H2/H3≤80%. This can prevent the volumes of the first adhesive overflow region 231 and the second adhesive overflow region 233 from being excessively large, and make the sealing region 232 less prone to cracking due to bending, which otherwise causes corrosion on other layer structures of the first shell 210 and/or the second shell 220 by the electrolyte. In addition, this allows for a small amount of water vapor permeating into the packaging bag 200 through the sealing region 232, thereby slowing down the expansion speed of the packaging bag 200, reducing the probability of the packaging bag 200 rupturing and causing electrolyte leakage and failure of the battery cell 10, and improving the reliability and service life of the battery.

In some embodiments, the average thickness of the first segment 2321 is H1, the average thickness of the second segment 2322 is H2, and the average thickness of the third segment 2324 is H3; where 35 μm≤H1≤110 μm, 10 μm≤H2≤60 μm, and 35 μm≤H3≤110 μm. For example, H1 may be 35 μm, 70 μm, 110 μm, or the like. H2 may be 10 μm, 45 μm, 60 μm, or the like. H3 may be 35 μm, 75 μm, 110 μm, or the like.

The average thickness H1 of the first segment 2321 and the average thickness H3 of the third segment 2324 satisfy 35 μm≤H1≤110 μm and 35 μm≤H3≤110 μm. This allows for a relatively high bonding strength between the first shell 210 and the second shell 220, resulting in good sealing performance of the packaging bag 200, and reducing the probability of electrolyte leakage. In addition, this allows for a small amount of water vapor permeating into the packaging bag 200 through the sealing region 232.

The average thickness H2 of the second segment 2322 satisfies 10 μm≤H2≤60 μm. This can prevent the volumes of the first adhesive overflow region 231 and the second adhesive overflow region 233 from being excessively large, and make the sealing region 232 less prone to cracking due to bending, which otherwise causes corrosion on other layer structures of the first shell 210 and/or the second shell 220 by the electrolyte. In addition, this allows for a smaller amount of water vapor permeating into the packaging bag 200 through the sealing region 232, thereby slowing down the expansion speed of the packaging bag 200, reducing the probability of the packaging bag 200 rupturing and causing electrolyte leakage and failure of the battery cell 10, and improving the reliability and service life of the battery.

In some embodiments, the width of the first segment 2321 is W1, the width of the second segment 2322 is W2, a width of the third segment 2324 is W3, and the width of the sealing region 232 is W; where 5%≤W1/W≤50%, 5%≤W2/W≤50%, and 5%≤W3/W≤50%. For example, W1/W may be 5%, 25%, 50%, or the like. W2/W may be 5%, 30%, 50%, or the like. W3/W may be 5%, 35%, 50%, or the like.

The width W1 of the first segment 2321, the width W3 of the third segment 2324, and the width W of the sealing region 232 satisfy 5%≤W1/W≤50% and 5%≤W3/W≤50%. This allows for a relatively high bonding strength between the first shell 210 and the second shell 220, resulting in good sealing performance of the packaging bag 200, and reducing the probability of electrolyte leakage. In addition, this allows for a small amount of water vapor permeating into the packaging bag 200 through the sealing region 232.

The width W2 of the second segment 2322 and the width W of the sealing region 232 satisfy 5%≤W2/W≤50%. This allows for a small amount of water vapor permeating into the packaging bag 200 through the sealing region 232. In addition, this can prevent the volumes of the first adhesive overflow region 231 and the second adhesive overflow region 233 from being excessively large, and make the sealing region 232 less prone to cracking due to bending, which otherwise causes corrosion on other layer structures of the first shell 210 and/or the second shell 220 by the electrolyte.

In some embodiments, the width of the first segment 2321 is W1, the width of the second segment 2322 is W2, the width of the third segment 2324 is W3, and the width of the sealing region 232 is W, satisfying 0.15 mm≤W1≤4 mm, 0.15 mm≤W2≤4 mm, 0.15 mm≤W3≤4 mm, and 3 mm≤W≤8 mm. For example, W1 may be 0.15 mm, 1.8 mm, 4 mm, or the like. W2 may be 0.15 mm, 2.3 mm, 4 mm, or the like. W3 may be 0.15 mm, 2.8 mm, 4 mm, or the like. W may be 3 mm, 5 mm, 8 mm, or the like.

The width W1 of the first segment 2321 and the width W3 of the third segment 2324 satisfy 0.15 mm≤W1≤4 mm and 0.15 mm≤W3≤4 mm. This allows for a relatively high bonding strength between the first shell 210 and the second shell 220, resulting in good sealing performance of the packaging bag 200, and reducing the probability of electrolyte leakage. In addition, this allows the space occupied by the first segment 2321 and the third segment 2324 to be relatively small, helping to increase the energy density of the battery.

The width W2 of the second segment 2322 satisfies 0.15 mm≤W2≤4 mm. This allows for a small amount of water vapor permeating into the packaging bag 200 through the sealing region 232. In addition, this can prevent the volumes of the first adhesive overflow region 231 and the second adhesive overflow region 233 from being excessively large, and make the sealing region 232 less prone to cracking due to bending, which otherwise causes corrosion on other layer structures of the first shell 210 and/or the second shell 220 by the electrolyte.

The width W of the sealing region 232 satisfies 3 mm≤W≤8 mm. This allows for a relatively high bonding strength between the first shell 210 and the second shell 220, resulting in good sealing performance of the packaging bag 200, and reducing the probability of electrolyte leakage. In addition, this allows the space occupied by the sealing region 232 to be relatively small, helping to increase the energy density of the battery.

In some embodiments, the sealing region 232 further includes a second transition segment 2325, where the second transition segment 2325 is connected between the second segment 2322 and the third segment 2324, and a thickness of the second transition segment 2325 gradually increases along a direction approaching the electrode assembly 100.

In some embodiments, the thickness of the second transition segment 2325 is a dimension of the second transition segment 2325 in the thickness direction Z of the sealing portion 230.

The sealing region 232 further includes the second transition segment 2325; the second transition segment 2325 is connected between the second segment 2322 and the third segment 2324; and the thickness of the second transition segment 2325 gradually increases along the direction approaching the electrode assembly 100. This allows for a smooth transition between the second segment 2322 and the third segment 2324 with different thicknesses, facilitating the press-forming of the second segment 2322 and the third segment 2324.

In some embodiments, a surface of the second segment 2322 along the thickness direction Z is a flat surface.

The surface of the second segment 2322 along the thickness direction Z being a flat surface can be understood in a broad sense, that is, the surface of the second segment 2322 along the thickness direction Z can be considered as a flat surface provided that a distance difference between the surface of the second segment 2322 along the thickness direction Z and a vertical plane (X-Y plane) in the thickness direction of the sealing portion 230 is less than a threshold.

The surface of the second segment 2322 along the thickness direction being the flat surface facilitates the press-forming of the second segment 2322.

Referring to FIG. 1 and FIG. 2, in some embodiments, the first shell 210 further includes a first metal layer 212, a first connection layer 213, and a first protective layer 214 sequentially stacked, where the first bonding layer 211 is disposed on a side of the first metal layer 212 facing away from the first connection layer 213. The second shell 220 further includes a second metal layer 222, a second connection layer 223, and a second protective layer 224 sequentially stacked, where the second bonding layer 221 is disposed on a side of the second metal layer 222 facing away from the second connection layer 223.

In some embodiments, the first metal layer 212 and the second metal layer 222 may be made of aluminum (Al) and have good ductility, facilitating the press-forming of the sealing region 232.

In some embodiments, the first connection layer 213 and the second connection layer 223 may be made of adhesive, enabling better connection between the first metal layer 212 and the first protective layer 214, and between the second metal layer 222 and the second protective layer 224, thereby making the layered structures of the first shell 210 and the second shell 220 more stable and less prone to delamination.

In some embodiments, the first protective layer 214 and the second protective layer 224 may be made of polyamide (PA, Nylon), polyethylene terephthalate (PET, polyethylene terephthalate), or a mixed material of polyamide and polyethylene terephthalate, have good wear resistance, chemical resistance, and corrosion resistance, and are capable of providing good protection to the first metal layer 212, the first connection layer 213, the first bonding layer 211, the second metal layer 222, the second connection layer 223, and the second bonding layer 221.

Referring to FIG. 5, FIG. 5 is a schematic diagram of a partial structure of a battery cell according to some embodiments of this application.

In some other embodiments, the surface of the second segment 2322 along the thickness direction Z is a concave-convex surface.

The surface of the second segment 2322 along the thickness direction Z being a concave-convex surface can enhance the bonding strength between the first shell 210 and the second shell 220.

Referring to Table 1, the battery cell 10 according to these embodiments shown in FIG. 1 and FIG. 2 is used as an example for test illustration in Table 1. In Table 1, H1 is the average thickness of the first segment 2321; H2 is the average thickness of the second segment 2322; a width proportion of the first segment is a ratio of the width W1 of the first segment 2321 to the width W of the sealing region 232; a width proportion of the second segment is a ratio of the width W2 of the second segment 2322 to the width W of the sealing region 232; and a proportion of the water vapor penetration amount is a ratio of a water vapor penetration amount of each example to a water vapor penetration amount of Comparative Example 1. The first shell 210 and the second shell 220 each use an aluminum-plastic film with a thickness of 153 μm (before hot pressing). A total width W of the sealing region 232 is 4 mm.

TABLE 1
Test of water vapor penetration amount of battery cell

| | | | | Total width of sealing | | | |
|---|---|---|---|---|---|---|---|
| | | | | region of 4 mm | | | |
| | | | | Width | Width | Water vapor | Proportion of |
| | | | | proportion | proportion | penetration | water vapor |
| | H1 | H2 | | of first | of second | amount | penetration |
| | (μm) | (μm) | H2/H1 | segment | segment | (ppm) | amount |
| Comparative | 75 | 75 | 100% | 100% | | 114.5 | 100% |
| Example 1 | | | | | | | |
| Example 1 | 75 | 7.5 | 10% | 50% | 50% | 36.9 | 32.2% |
| Example 2 | 75 | 10.5 | 14% | 50% | 50% | 39.0 | 34.1% |
| Example 3 | 75 | 35 | 46.7% | 50% | 50% | 57.0 | 49.8% |
| Example 4 | 75 | 60 | 80% | 50% | 50% | 68.7 | 60.0% |
| Example 5 | 20 | 20 | 100% | 50% | 50% | 30.3 | 26.5% |
| Example 6 | 35 | 20 | 17.5% | 50% | 50% | 35.7 | 31.2% |
| Example 7 | 60 | 20 | 33.3% | 50% | 50% | 45 | 39.3% |
| Example 8 | 80 | 20 | 25% | 50% | 50% | 51.9 | 45.3% |
| Example 9 | 110 | 20 | 18.2% | 50% | 50% | 65.7 | 57.4% |
| Example 10 | 130 | 20 | 15.4% | 50% | 50% | 75.6 | 66.0% |

A test method for water vapor penetration amount was as follows:
(1) A pit was punched in a packaging film, and the pit had a length of 80 mm, a width of 60 mm, and a depth of 5 mm.
(2) An unpunched packaging film and a punched packaging film were stacked. Top edges, bottom edges, and first side edges of the two packaging films were sealed to form a top sealing edge, a bottom sealing edge, and a first side sealing edge of the packaging bag, with a sealing temperature of 190° C., a sealing time of 3 s, and a sealing width of 4 mm. Different sealing heads were used to design sealing thicknesses into thicknesses and widths corresponding to examples and comparative example.
(3) The packaging bag was baked, with a baking temperature of 85° C. and a baking time of 4 hours.
(4) In an environment with a temperature less than 28° C. and a relative humidity less than 2%, 5.345 g of a dimethyl carbonate (DMC) solution was injected from a second side edge of the packaging bag. The second side edge was sealed to form the second side sealing edge of the packaging bag, with the sealing conditions identical to those of the top edge, bottom edge, and first side edge of the above packaging film.
(5) An excess packaging film was cut off along the second side sealing edge of the packaging bag to form a final packaging bag for test.
(6) A syringe was used to extract 0.5 g of dimethyl carbonate solution from the packaging bag. 1 to 2 drops of the dimethyl carbonate solution were dropwise added to a titration cell of a water vapor detection instrument. The water content of the dimethyl carbonate solution was tested and recorded as a1 (μg). A ratio of the water content to the weight b1 (g) of the dimethyl carbonate solution droplets was calculated as c1=a1/b1 (μg/g or ppm).
(7) The above packaging bags for test were stored in an environment with a temperature of 60° C. and a relative humidity of 90% for 28 days. Then, the step (6) was repeated. The water content of the dimethyl carbonate solution was tested and recorded as a2 (μg). A ratio of the water content to the weight b2 (g) of the dimethyl carbonate solution droplets was calculated as c2=a2/b2 (μg/g or ppm).
(8) A water vapor penetration amount was calculated as Q=c2−c1.

In the preparation processes of the above packaging bags for test, the comparative example differed from the examples in that in the comparative example, the sealing surface of the sealing head used to seal the packaging film was flat, while in the examples, the sealing surface of the sealing head used to seal the packaging film was stepped to form multiple segments with different thicknesses. Other steps were the same.

From Table 1, it can be seen that:
(1) From comparison of Examples 1 to 4 and 6 to 10 with Comparative Example 1, it can be seen that H2/H1 is smaller, both the water vapor penetration amount and the proportion thereof are smaller. From comparison of Example 5 with Comparative Example 1, it can be seen that when H2/H1 is the same and the average thicknesses of H1 and H2 are smaller, both the water vapor penetration amount and the proportion thereof are smaller, thereby slowing down the expansion speed of the packaging bag, reducing the probability of the packaging bag rupturing and causing electrolyte leakage and failure of the battery cell using the packaging bag, and improving the reliability and service life of the battery using the packaging bag.
(2) From comparison of Examples 1 to 4, it can be seen that when the average thickness of the first segment remains unchanged, a smaller average thickness of the second segment leads to a smaller water vapor penetration amount. To be specific, reducing the average thickness of the second segment can further reduce the water vapor penetration amount and the proportion thereof in the battery cell. When H2 is less than 10 μm (Example 1), the water vapor penetration amount and the proportion thereof are relatively small. However, when H2 is less than 10 μm, the average thickness of the second segment is relatively small, leading to an excessive amount of adhesive overflowing in the sealing region. In addition, when the sealing region is subjected to stress, the first bonding layer and the second bonding layer are prone to damage, thus increasing the risk of corrosion on the first metal layer and the second metal layer. Furthermore, the adhesion strength of portions of the first bonding layer and the second bonding layer corresponding to the second segment is weak, and the first bonding layer and the second bonding layer are prone to separation.
(3) From comparison of Examples 5 to 10, it can be seen that when the average thickness of the second segment remains unchanged, a smaller average thickness of the first segment leads to a smaller water vapor penetration amount. To be specific, reducing the average thickness of the first segment can further reduce the water vapor penetration amount and the proportion thereof in the battery cell. When H1 is less than 35 μm (Example 5), the water vapor penetration amount and the proportion thereof are relatively small. However, when H1 is less than 35 μm, the average thickness of the first segment is relatively small, leading to an excessive amount of adhesive overflowing in the sealing region. In addition, when the sealing region is subjected to stress, the first bonding layer and the second bonding layer are prone to damage, thus increasing the risk of corrosion on the first metal layer and the second metal layer. Furthermore, the adhesion strength of portions of the first bonding layer and the second bonding layer corresponding to the first segment is weak, and the first bonding layer and the second bonding layer are prone to separation. When H1 is greater than 110 μm (Example 10), both the water vapor penetration amount and the proportion thereof are relatively large.

Referring to Table 2, the battery cell 10 according to these embodiments shown in FIG. 3 and FIG. 4 is used as an example for test illustration in Table 2. The definitions of H1, H2, the width proportion of the first segment, the width proportion of the second segment, and the proportion of the water vapor penetration amount in Table 2 are the same as those in Table 1. Details are not described herein again. H3 is the average thickness of the third segment 2324, and the width proportion of the third segment is a ratio of the width W3 of the third segment 2324 to the width W of the sealing region 232. The first shell 210 and the second shell 220 each use an aluminum-plastic film with a thickness of 153 μm (before hot pressing), and a total width W of the sealing region 232 is 4 mm. The test method for water vapor penetration amount is the same as that in Table 1. Details are not described herein again.

From Table 2, it can be seen that:
(1) From comparison of Examples 11 to 20 with Comparative Example 2, it can be seen that the examples of this application have thinner second segments and smaller water vapor penetration amounts and proportions thereof, thereby slowing down the expansion speed of the packaging bag, reducing the probability of the packaging bag rupturing and causing electrolyte leakage and failure of the battery cell using the packaging bag, and improving the reliability and service life of the battery using the packaging bag.

TABLE 2
Test of water vapor penetration amount of battery cell

| | | | | | | Width | Width | Width | Water | Proportion |
|---|---|---|---|---|---|---|---|---|---|---|
| | | | | | | pro- | pro- | pro- | vapor | of water |
| | | | | | | portion | portion | portion | penetration | vapor |
| | H1 | H2 | H3 | H2/ | H2/ | of first | of second | of third | amount | penetration |
| | (μm) | (μm) | (μm) | H1 | H3 | segment | segment | segment | (ppm) | amount |
| Comparative | 75 | 75 | 75 | 100% | 100% | 100% | | | 114.5 | 100% |
| Example 2 | | | | | | | | | | |
| Example 11 | 75 | 35 | 75 | 46.7% | 46.7% | 52% | 3% | 45% | 93.2 | 81.4% |
| Example 12 | 75 | 35 | 75 | 46.7% | 46.7% | 50% | 5.0% | 45% | 93.0 | 81.2% |
| Example 13 | 75 | 35 | 75 | 46.7% | 46.7% | 20% | 35.0% | 45% | 79.0 | 69.0% |
| Example 14 | 75 | 35 | 75 | 46.7% | 46.7% | 5% | 50.0% | 45% | 72.0 | 62.9% |
| Example 15 | 75 | 35 | 75 | 46.7% | 46.7% | 3% | 52.0% | 45% | 71.8 | 62.7% |
| Example 16 | 75 | 35 | 75 | 46.7% | 46.7% | 3% | 45% | 52% | 73.2 | 63.9% |
| Example 17 | 75 | 35 | 75 | 46.7% | 46.7% | 5% | 45% | 50% | 73.4 | 64.1% |
| Example 18 | 75 | 35 | 75 | 46.7% | 46.7% | 35% | 45% | 20% | 75.9 | 66.3% |
| Example 19 | 75 | 35 | 75 | 46.7% | 46.7% | 50% | 45% | 5% | 77.2 | 67.4% |
| Example 20 | 75 | 35 | 75 | 46.7% | 46.7% | 52% | 45% | 3% | 77.4 | 67.6% |

(2) From comparison of Examples 11 to 15, it can be seen that when the width proportion of the third segment remains unchanged, a larger width proportion of the second segment leads to a smaller water vapor penetration amount and proportion thereof. To be specific, increasing the width proportion of the second segment can further reduce the water vapor penetration amount and the proportion thereof in the battery cell. When the width proportion of the second segment is less than 5% (Example 11), both the water vapor penetration amount and the proportion thereof are relatively large. In addition, due to the small width of the second segment, the precision requirements for the sealing head are relatively high, the processed sealing head is relatively sharp and accelerates wear, and the dimensional consistency of the sealing head is relatively poor. When the width proportion of the second segment is greater than 50% (Example 15), the water vapor penetration amount and the proportion thereof are relatively small. However, the width proportion of the second segment being greater than 50% leads to an excessive amount of adhesive overflowing in the sealing region. In addition, when the sealing region is subjected to stress, the first bonding layer and the second bonding layer are prone to damage, thus increasing the risk of corrosion on the first metal layer and the second metal layer.
(3) From comparison of Example 11 with Examples 12 to 14, it can be seen that in Examples 12 to 14, the width proportion of the second segment falls within a range of 5.0% to 50.0%, and the water vapor penetration amount is relatively small, while in Example 11, the width proportion of the first segment and the width proportion of the second segment fall outside the range of 5.0% to 50.0%, and the water vapor penetration amount is relatively large but still better than that of Comparative Example 2.
(4) From comparison of Examples 16 to 20, it can be seen that when the width proportion of the second segment remains unchanged, a smaller width proportion of the first segment leads to a smaller water vapor penetration amount and proportion thereof. To be specific, reducing the width proportion of the first segment can further reduce the water vapor penetration amount and the proportion thereof in the battery cell. When the width proportion of the first segment is greater than 50% (Example 20), both the water vapor penetration amount and the proportion thereof are relatively large, the width of the third segment is relatively small, the precision requirements for the sealing head are relatively high, the processed sealing head is relatively sharp and accelerates wear, and the dimensional consistency of the sealing head is relatively poor. When the width proportion of the first segment is less than 5% (Example 16), the water vapor penetration amount and the proportion thereof are relatively small. However, the width proportion of the first segment being less than 5% results in a relatively small width of the first segment, the precision requirements for the sealing head are relatively high, the processed sealing head is relatively sharp and accelerates wear, and the dimensional consistency of the sealing head is relatively poor.
(5) From comparison of Example 20 and Examples 17 to 19, it can be seen that in Examples 17 to 19, the width proportion of the first segment falls within a range of 5.0% to 50.0%, and the water vapor penetration amount is relatively small, while in Example 20, the width proportion of the first segment and the width proportion of the third segment fall outside the range of 5.0% to 50.0%, and the water vapor penetration amount is relatively large but still better than that of Comparative Example 2.

Referring to Table 3, the battery cell 10 according to these embodiments shown in FIG. 3 and FIG. 4 is used as an example for test illustration in Table 3. The definitions of H1, H2, H3, the width proportion of the first segment, the width proportion of the second segment, the width proportion of the third segment, and the proportion of the water vapor penetration amount in Table 3 are the same as those in Table 2. Details are not described herein again. The first shell 210 and the second shell 220 each use an aluminum-plastic film with a thickness of 153 μm (before hot pressing), and a total width W of the sealing region 232 is 4 mm. The test method for water vapor penetration amount is the same as that in Table 1. Details are not described herein again.

TABLE 3
Test of water vapor penetration amount of battery cell

| | | | | | | Width | Width | Width | Water | Proportion |
|---|---|---|---|---|---|---|---|---|---|---|
| | | | | | | pro- | pro- | pro- | vapor | of water |
| | | | | | | portion | portion | portion | penetration | vapor |
| | H1 | H2 | H3 | H2/ | H2/ | of first | of second | of third | amount | penetration |
| | (μm) | (μm) | (μm) | H1 | H3 | segment | segment | segment | (ppm) | amount |
| Comparative | 75 | 75 | 75 | 100% | 100% | 32.5% | 35.0% | 32.5% | 114.5 | 100% |
| Example 3 | | | | | | | | | | |
| Example 21 | 75 | 7.5 | 75 | 10% | 10% | 32.5% | 35.0% | 32.5% | 49.2 | 43.0% |
| Example 22 | 75 | 10.5 | 75 | 14% | 14% | 32.5% | 35.0% | 32.5% | 52.1 | 45.5% |
| Example 23 | 75 | 35 | 75 | 46.7% | 46.7% | 32.5% | 35.0% | 32.5% | 79.2 | 69.2% |
| Example 24 | 75 | 60 | 75 | 80% | 80% | 32.5% | 35.0% | 32.5% | 99.6 | 87.0% |
| Example 25 | 20 | 20 | 75 | 100% | 26.7% | 32.5% | 35.0% | 32.5% | 45.2 | 39.5% |
| Example 26 | 35 | 20 | 75 | 57.1% | 26.7% | 32.5% | 35.0% | 32.5% | 50.2 | 43.8% |
| Example 27 | 60 | 20 | 75 | 33.3% | 26.7% | 32.5% | 35.0% | 32.5% | 57.8 | 50.5% |
| Example 28 | 80 | 20 | 75 | 25% | 26.7% | 32.5% | 35.0% | 32.5% | 64.4 | 56.2% |
| Example 29 | 110 | 20 | 75 | 18.2% | 26.7% | 32.5% | 35.0% | 32.5% | 73.3 | 64.0% |
| Example 30 | 130 | 20 | 75 | 15.4% | 26.7% | 32.5% | 35.0% | 32.5% | 81.3 | 71.0% |
| Example 31 | 75 | 20 | 20 | 26.7% | 100% | 32.5% | 35.0% | 32.5% | 48.7 | 42.5% |
| Example 32 | 75 | 20 | 35 | 26.7% | 57.1% | 32.5% | 35.0% | 32.5% | 52.9 | 46.2% |
| Example 33 | 75 | 20 | 60 | 26.7% | 33.3% | 32.5% | 35.0% | 32.5% | 59.0 | 51.5% |
| Example 34 | 75 | 20 | 80 | 26.7% | 25% | 32.5% | 35.0% | 32.5% | 63.9 | 55.8% |
| Example 35 | 75 | 20 | 110 | 26.7% | 18.2% | 32.5% | 35.0% | 32.5% | 71.0 | 62.0% |
| Example 36 | 75 | 20 | 130 | 26.7% | 15.4% | 32.5% | 35.0% | 32.5% | 77.9 | 68.0% |

From Table 3, it can be seen that:
(1) From comparison of Examples 21 to 36 with Comparative Example 3, it can be seen that when H2/H3 is smaller, both the water vapor penetration amount and the proportion thereof are smaller. From comparison of Examples 21 to 24 and 26 to 36 with Comparative Example 3, it can be seen that when H2/H1 is smaller, both the water vapor penetration amount and the proportion thereof are smaller. From comparison of Example 25 with Comparative Example 3, it can be seen that when H2/H1 is the same and the average thicknesses of H1 and H2 are smaller, both the water vapor penetration amount and the proportion thereof are smaller, thereby slowing down the expansion speed of the packaging bag, reducing the probability of the packaging bag rupturing and causing electrolyte leakage and failure of the battery cell using the packaging bag, and improving the reliability and service life of the battery using the packaging bag.
(2) From comparison of Examples 21 to 24, it can be seen that when the average thicknesses of the first segment and the third segment remain unchanged, a smaller average thickness of the second segment leads to a smaller water vapor penetration amount. To be specific, reducing the average thickness of the second segment can further reduce the water vapor penetration amount and the proportion thereof in the battery cell. However, when H2 is less than 10 μm (Example 21), the average thickness of the second segment is relatively small, leading to an excessive amount of adhesive overflowing in the sealing region. In addition, when the sealing region is subjected to stress, the first bonding layer and the second bonding layer are prone to damage, thus increasing the risk of corrosion on the first metal layer and the second metal layer. Furthermore, the adhesion strength of portions of the first bonding layer and the second bonding layer corresponding to the second segment is weak, and the first bonding layer and the second bonding layer are prone to separation.
(3) From comparison of Example 21 with Examples 22 to 24, it can be seen that in Examples 22 to 24, the thickness of the second segment falls within a range of 10 μm to 60 μm, the values of H2/H1 and H2/H3 fall within a range of 13% to 80%, and the water vapor penetration amount is relatively small; while in Example 21, the thickness of the second segment falls outside the range of 10 μm to 60 μm, the values of H2/H1 and H2/H3 fall outside the range of 13% to 80%, and the water vapor penetration amount is relatively large but still better than that of Comparative Example 3.
(4) From comparison of Examples 25 to 30, it can be seen that when the average thicknesses of the second segment and the third segment remain unchanged, a smaller average thickness of the first segment leads to a smaller water vapor penetration amount. To be specific, reducing the average thickness of the first segment can further reduce the water vapor penetration amount and the proportion thereof in the battery cell. When H1 is less than 35 μm (Example 25), the water vapor penetration amount and the proportion thereof are relatively small. However, H1 being less than 35 μm leads to a relatively small average thickness of the first segment, thus leading to an excessive amount of adhesive overflowing in the sealing region. In addition, when the sealing region is subjected to stress, the first bonding layer and the second bonding layer are prone to damage, thus increasing the risk of corrosion on the first metal layer and the second metal layer. Furthermore, the adhesion strength of portions of the first bonding layer and the second bonding layer corresponding to the first segment is weak, and the first bonding layer and the second bonding layer are prone to separation. However, when H1 is greater than 110 μm (Example 30), both the water vapor penetration amount and the proportion thereof are relatively large.
(5) From comparison of Example 30 with Examples 26 to 29, it can be seen that in Examples 26 to 29, the thickness of the first segment falls within a range of 35 μm to 110 μm, and the water vapor penetration amount is relatively small; while in Example 30, the thickness of the first segment falls outside the range of 35 μm to 110 μm, and the water vapor penetration amount is relatively large but still better than that of Comparative Example 3.
(6) From comparison of Examples 31 to 36, it can be seen that when the average thicknesses of the first segment and the second segment remain unchanged, a smaller average thickness of the third segment leads to a smaller water vapor penetration amount. To be specific, reducing the average thickness of the third segment can further reduce the water vapor penetration amount and the proportion thereof in the battery cell. When H3 is less than 35 μm (Example 31), the water vapor penetration amount and the proportion thereof are relatively small. However, H3 being less than 35 μm leads to a relatively small average thickness of the third segment, thus leading to an excessive amount of adhesive overflowing in the sealing region. In addition, when the sealing region is subjected to stress, the first bonding layer and the second bonding layer are prone to damage, thus increasing the risk of corrosion on the first metal layer and the second metal layer. Furthermore, the adhesion strength of portions of the first bonding layer and the second bonding layer corresponding to the first segment is weak, and the first bonding layer and the second bonding layer are prone to separation. However, when H3 is greater than 110 μm (Example 36), both the water vapor penetration amount and the proportion thereof are relatively large.
(7) From comparison of Example 36 and Examples 32 to 35, it can be seen that in Examples 32 to 35, the thickness of the third segment falls within a range of 35 μm to 110 μm, and the water vapor penetration amount is relatively small; while in Example 36, the thickness of the third segment falls outside the range of 35 μm to 110 μm, and the water vapor penetration amount is relatively large but still better than that of Comparative Example 3.

Referring to Table 4, a thickness proportion of the first segment is a ratio of the thickness H1 of the first segment 2321 to the thickness of the sealing region in Comparative Example 4; a thickness proportion of the second segment is a ratio of the thickness H2 of the second segment 2322 to the thickness of the sealing region in Comparative Example 4; a thickness proportion of the third segment is a ratio of the thickness H3 of the third segment 2324 to the thickness of the sealing region in Comparative Example 4; and the definitions of a width proportion of the first segment, a width proportion of the second segment, and a width proportion of the third segment are the same as those in Table 3. Details are not described herein again. A sealing tensile force is a maximum tensile force required to pull apart the first shell and the second shell of the sealing region. The thickness of the sealing region in Comparative Example 4 is 75 μm, and the width W of the sealing region in each of Comparative Example 4 and Examples 37 to 41 is 4 mm.

A test method for the sealing tensile force is as follows:
(1) The battery cell was disassembled, and the packaging bag and the sealing portion on one side of the packaging bag were retained.
(2) Referring to FIG. 3, the packaging bag 200 was cut along the width direction X of the packaging bag 200 on one side of the packaging bag 200 to form a sample strip. The sample strip included the sealing portion 230 of the packaging bag 200, and the sample strip included a portion of the first shell 210 and a portion of the second shell 220. A cutting width of the sample strip (that was a dimension of the sample strip along the length direction Y of the packaging bag 200) was 8 mm, and a cutting length of the sample strip (that was a dimension of the sample strip along the width direction X of the packaging bag 200) was 20 mm to 50 mm.
(3) The sample strip was opened, so that a portion of the first shell 210 and a portion of the second shell 220 in the sample strip respectively extended in opposite directions.
(4) Two ends of the opened sample strip were respectively connected and locked to two clamps of a tensile testing machine, and a distance between the two clamps was 25 mm to 50 mm.
(5) The two clamps moved in opposite directions to stretch the sample strip at a stretching speed of 175 mm/min. A maximum tensile force of the tensile testing machine was recorded, which was the sealing tensile force of the packaging bag.

TABLE 4
Test of sealing tensile force of battery cell

| | Thickness | | | | | |
|---|---|---|---|---|---|---|
| | proportion | | | | | |
| | of first | Thickness | Width | Width | Width | Sealing |
| | segment | proportion | proportion | proportion | proportion | tensile |
| | and third | of second | of first | of second | of third | force |
| | segment | segment | segment | segment | segment | (N) |
| Comparative | 100% | 100% | 100% | | | 71.4 |
| Example 4 | | | | | | |
| Example 37 | 100% | 47% | 47.5% | 5.0% | 47.5% | 70.5 |
| Example 38 | 100% | 47% | 32.5% | 35.0% | 32.5% | 69.2 |
| Example 39 | 100% | 47% | 25.0% | 50.0% | 25.0% | 71.8 |
| Example 40 | 100% | 80% | 32.5% | 35.0% | 32.5% | 70.3 |
| Example 41 | 100% | 13% | 32.5% | 35.0% | 32.5% | 71.6 |

From Table 4, it can be seen that:
(1) From comparison of Examples 37 to 41 with Comparative Example 4, it can be seen that a difference in the sealing tensile force is small. The provision of the second segment with a relatively small thickness in this application can reduce the water vapor penetration amount of the battery cell and has a relatively small impact on the sealing effect of the sealing portion.
(2) From comparison of Example 39 with Comparative Example 4, it can be seen that when the thickness proportion of the second segment was 47% and the width proportion of the second segment was 50.0%, the sealing tensile force of the battery cell was greater than the sealing tensile force of the battery cell in Comparative Example 4, reducing the water vapor penetration amount of the battery cell and allowing the sealing portion to have a better sealing effect.
(3) From comparison of Example 41 with Comparative Example 4, it can be seen that when the thickness proportion of the second segment is 13% and the width proportion of the second segment is 35.0%, the sealing tensile force of the battery cell is greater than the sealing tensile force of the battery cell in Comparative Example 4, reducing the water vapor penetration amount of the battery cell and allowing the sealing portion to have a better sealing effect.

An embodiment of this application provides a battery including the battery cell 10 of any one of the above solutions.

An embodiment of this application provides an electric apparatus including the battery of any one of the above solutions, where the battery is configured to provide electrical energy.

The electric apparatus may be any one of the foregoing apparatuses or systems using a battery.

It should be noted that, in the absence of conflict, these embodiments and the features in these embodiments of this application can be combined with each other.

The foregoing embodiments are merely preferred embodiments of this application which are not intended to limit this application. Those skilled in the art understand that this application may have various modifications and variations. Any modifications, equivalent replacements, improvements, and the like made without departing from the spirit and principle of this application shall fall within the protection scope of this application.

What is claimed is:

1. A battery cell, comprising:
an electrode assembly; and
a packaging bag accommodating the electrode assembly, wherein the packaging bag comprises a first shell and a second shell; the first shell comprises a first bonding layer; the second shell comprises a second bonding layer; the first bonding layer is bonded to the second bonding layer to form a sealing portion; the sealing portion comprises a first adhesive overflow region, a sealing region, and a second adhesive overflow region; and along a width direction of the sealing portion, the sealing region is located between the first adhesive overflow region and the second adhesive overflow region; and
the sealing region comprises a first segment and a second segment; along the width direction of the sealing portion, the second segment is closer to the electrode assembly than the first segment; and an average thickness of the second segment is less than an average thickness of the first segment.

2. The battery cell according to claim 1, wherein the average thickness of the first segment is H1, and the average thickness of the second segment is H2; wherein 13%≤H2/H1≤80%.

3. The battery cell according to claim 1, wherein the average thickness of the first segment is H1, and the average thickness of the second segment is H2; wherein 35 μm≤H1≤110 μm, and 10 μm≤H2≤60 μm.

4. The battery cell according to claim 1, wherein the sealing region further comprises a first transition segment; the first transition segment is connected between the first segment and the second segment; and a thickness of the first transition segment gradually increases along a direction away from the electrode assembly.

5. The battery cell according to claim 1, wherein the sealing region further comprises a third segment; along the width direction of the sealing portion, the second segment is disposed between the third segment and the first segment; and the average thickness of the second segment is less than an average thickness of the third segment.

6. The battery cell according to claim 5, wherein the average thickness of the first segment is H1, the average thickness of the second segment is H2, and the average thickness of the third segment is H3; wherein 13%≤H2/H1≤80%, and 13%≤H2/H3≤80%.

7. The battery cell according to claim 6, wherein 13%≤H2/H1≤50%, and 13%≤H2/H3≤50%.

8. The battery cell according to claim 5, wherein the average thickness of the first segment is H1, the average thickness of the second segment is H2, and the average thickness of the third segment is H3; wherein 35 μm≤H1≤110 μm, 10 μm≤H2≤60 μm, and 35 μm≤H3≤110 μm.

9. The battery cell according to claim 8, wherein 35 μm≤H1≤70 μm, 10 μm≤H2≤45 μm, and 35 μm≤H3≤75 μm.

10. The battery cell according to claim 5, wherein a width of the first segment is W1, a width of the second segment is W2, a width of the third segment is W3, and a width of the sealing region is W; wherein 5%≤W1/W≤50%, 5%≤W2/W≤50%, and 5%≤W3/W≤50%.

11. The battery cell according to claim 1, wherein a width of the first segment is W1, a width of the second segment is W2, and a width of the sealing region is W; wherein 5%≤W1/W≤50%, and 5%≤W2/W≤50%.

12. The battery cell according to claim 1, wherein 5%≤W1/W≤25%, and 5%≤W2/W≤30%.

13. The battery cell according to claim 5, wherein a width of the first segment is W1, a width of the second segment is W2, a width of the third segment is W3, and a width of the sealing region is W, satisfying 0.15 mm≤W1≤4 mm, 0.15 mm≤W2≤4 mm, 0.15 mm≤W3≤4 mm, and 3 mm≤W≤8 mm.

14. The battery cell according to claim 1, wherein a width of the first segment is W1, a width of the second segment is W2, and a width of the sealing region is W, satisfying 0.15 mm≤W1≤4 mm, 0.15 mm≤W2≤4 mm, and 3 mm≤W≤8 mm.

15. The battery cell according to claim 5, wherein the sealing region further comprises a second transition segment; the second transition segment is connected between the second segment and the third segment; and a thickness of the second transition segment gradually increases along a direction approaching towards the electrode assembly.

16. The battery cell according to claim 1, wherein a surface of the second segment along a thickness direction is a flat surface or a concave-convex surface.

17. The battery cell according to claim 1, wherein the battery cell comprises two or three or four sealing portions.

18. The battery cell according to claim 1, wherein the first bonding layer and the second bonding layer are made of a polypropylene material.

19. A battery, comprising the battery cell according to claim 1.

20. An electric apparatus, comprising the battery according to claim 19, wherein the battery is configured to provide electrical energy.
